(19) United States
(12) Patent Application Publication
(10) Pub. No.: US 2003/0004889 A1
(43) Pub. Date: Jan. 2, 2003

(54) Point-of-sale activation and subsequent registration of products

(75) Inventors: Barry J. Fiala, Memphis, TN (US); Mark B. Hodes, Memphis, TN (US)

Correspondence Address: Russell H. Walker, Walker, McKenzie & Walker, P.C., Suite 434, 6363 Poplar Avenue, Memphis, TN, 38119-4896, US

(73) Assignee: Riverborne Communications, LLC, Memphis, TN

(21) Appl. No.: 10/041,934

(22) Filed: Jan. 8, 2002

Related U.S. Application Data
(60) Provisional application No. 60/260,058, filed on Jan. 5, 2001.

(51) Int. Cl. G06F 17/60

(52) U.S. Cl. 705/64

(57) ABSTRACT

Methods and packaging for point-of-sale (“POS”) activation and subsequent registration of products. Prior to POS activation, the product is unactivated and cannot be used. Machine-readable activation at POS is disclosed such as a data-encoded activation strip, readable by a magnetic or optical scanner, or such as integrated circuit card (“ICC”) technology. Prior to POS activation, and preferably obscured from view, the package has a personalized identification number (“PIN”), such as alphanumeric characters with a scratch-off coating or peel-off label, or the PIN may be only readable by a magnetic or optical scanner, or may be encoded onto computer media, or may be data encoded within an ICC element. After activation, the product is registered with a registration database, whereby the PIN, and perhaps other information, is provided by the user over a communications channel, enabling the product to be utilized.

### CROSS REFERENCE TO RELATED APPLICATIONS

This application is a non-provisional application corresponding to pending U.S. Provisional Patent Application No. 60/260,058, filed Jan. 5, 2001, entitled Point of Sale Activation for Software and Metered Accounts, and claims priority benefit thereof.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to methods and apparatus for point-of-sale activation of products such as, for example, software, downloaded music and other copyrighted material, metered accounts, and other products, and related packaging for presentation to a purchaser prior to sale and for point-of-sale activation of such products. In particular, the present invention relates to methods and apparatus for the point-of-sale activation of such products, related packaging for presentation to a purchaser prior to sale and for point-of-sale activation of such products, and the subsequent registration of the products so as to enable the products to be used by a consumer.

2. Information Disclosure Statement

Prior art prepaid metered accounts associated with debit cards are well-known for providing access to goods and services, e.g., telephone services. Typically, a card having a personal identification number (“PIN”) thereon is sold at a retail outlet for a certain price. This PIN is associated with an already-activated metered account that is pre-credited with a certain predetermined value representing the value of services, e.g., telephone services, being purchased. Then, as the cardholder uses the telephone services, the cardholder provides the PIN and the account is successively debited for the services provided until the value of the card is exhausted. Often, the predetermined value credited to the metered account may be more than the actual purchase price of the debit card because of promotional pricing, etc. However, theft of services is a problem when such a scheme is used because unfettered access to the metered account is available to anyone who obtains knowledge of the PIN for the pre-activated metered account, necessitating the storage of such cards under lock and key by the retail merchant until the moment the cards are sold, thereby preventing the stocking of such cards on store shelves freely accessible by prospective purchasers.

An excellent and innovative approach to solving such theft of services for a metered account is given by Fiala, U.S. Pat. No. 5,918,909 (issued Jul. 6, 1999), fully included herein by reference thereto, disclosing how innovative packaging and a related method of use, in which a data-encoded activation strip on a card attached to a panel of a package, can permit a metered account to be activated at the point-of-sale, thereby allowing the packaged, but inactive, cards for the metered account to be placed on shelves of a retail store and removing the need for keeping such cards for metered accounts under lock and key prior to sale. Another example of solving such theft of services for a metered account is given by Smith et al., U.S. Pat. No. 5,777,305 (issued Jul. 7, 1998), fully included herein by reference thereto, disclosing that the data-encoded activation strip could be placed on the package itself rather than on the card, and also disclosing that a machine-readable identification number could be visible through a cutout in the package, so that either the data-encoded activation strip or the machine-readable identification number could be used to activate the metered account at the point-of-sale. However, the purpose of these prior art approaches, and of other improvements that have built upon these prior art approaches, was to provide point-of-sale activation of metered accounts, and the purpose of these prior art approaches and their improvements was completed after the point-of-sale activation of the metered account.

Some products, such as computer software, music, movies, entertainment products, telephone services, etc., are accessed and/or retrieved over well-known communications channels subsequent to purchase, such that all of, or a portion of, the products are delivered over the communications channel. Examples of such well-known communications channels are well-known dialup telephone voice or data connections, dedicated high-speed data channels, broadband cable transmission channels, radio and/or satellite communications channels, a packet-switched global data communications network (i.e., the so-called “internet”), etc. Additionally, some products or services, such as computer software, etc., have to be “registered” with a registration database, during which registration step the user of such products provides a purchased code, such as a PIN or serialized registration code, to the registration facility and may receive an “unlocking code,” etc., that permits use of the product or service by entering this unlocking code at the time of use of the product.

Furthermore, some products, particularly computer software products, face a problem of rapid obsolescence of inventory as the products are improved, corrected, and/or updated, such that older versions of the products must be discarded or returned by retailers, often at great expense to the retailer or manufacturer.

It is therefore desirable to provide improved packaging and methods for automated activation at point-of-sale of products, and further to provide improved apparatus and methods for subsequent registration of those products after point-of-sale activation. It is further desirable to solve the problem of inventory obsolescence of rapidly evolving data products such as computer software.

None of the known prior art references, either singly or in combination, disclose or suggest the present invention.

### BRIEF SUMMARY OF THE INVENTION

The present invention provides packaging of products for presentation to a prospective purchaser, provides for point-of-sale activation of the products, provides for subsequent post-activation registration of the products, and provides methods and apparatus for accomplishing such point-of-sale activation and subsequent registration of the products.

With all embodiments of the invention, the product being vended is unactivated and cannot be used prior to activation at the point-of-sale. Many equivalent means of machine-readable activation at the point-of-purchase are disclosed such as a data-encoded activation strip that can be read by a magnetic or optical scanner, or such as well-known so-called integrated circuit card (“ICC”) or “smart card” technology in which data within an integrated circuit is accessed at the point-of-purchase by a well-known ICC interface apparatus.

Prior to point-of-sale activation, and while the product to be vended is in the retail store for examination by a prospective purchaser, a personalized identification number (“PIN”) is preferably obscured from the view of the purchaser. The PIN may be human-readable alphanumeric characters and could be obscured, for example, by a well-known “scratch off” coating or “peel-off” label to provide evidence of a surreptitious attempt by another to view the PIN prior to purchase, or may be data that is only readable by a specialized machine such as a magnetic or optical scanner, or may be data that is encoded onto computer data storage media within the purchased package, or may be data that is encoded within an ICC element within the purchased package and readable only using a well-known ICC interface apparatus, or may be obscured simply by having the PIN hidden by or within the packaging itself. The PIN, even if visible, would not be usable until the product is activated at point-of-sale, but there would be a risk that the PIN, if visible, might be surreptitiously viewed and recorded prior to sale by someone desiring free use of the product, that this someone could simply wait until activation at point-of-sale by a bona fide purchaser, at which time the surreptitious viewer might be able to register and then use the product, possibly even preventing use of the product by the bona fide purchaser. Accordingly, it is very desirable that, prior to point-of-purchase activation, the PIN is obscured from viewing by a prospective purchaser so as to prevent surreptitious viewing and recording of the PIN by someone other than the eventual purchaser prior to purchase of the product by the eventual purchaser of the product. With some embodiments, vending and activation of the product occurs via a kiosk, which may perform a final manufacturing step of applying the PIN to the vended package at the time of sale.

Subsequent to point-of-sale activation, the method and apparatus of the present invention provide for registration of the purchased product/services with a registration database over a well-known communications channel, during which registration step the user of such products/services provides the PIN, and perhaps other related registration information, to the registration facility, thereby enabling the product/services to be utilized by the user. Optionally, the user may receive an “unlocking code,” etc., for subsequent use at the time the product/service is accessed or used by the user, thereby permitting use of the product or service, and, for some types of products/services, such as, for example, computer software products, updates or revisions, or perhaps even the entire product, are then downloaded over the communications channel (or perhaps even a different communications channel than the one used for registration). In some embodiments of the present invention, the registration and optional receipt of an unlocking code, as well as the optional downloading over the communications channel of updates or part or all of the product, may be automated, occurring at the first use of the product's computer data storage media without explicit request by the user.

It is an object of the present invention to provide packaging of products for presentation to a prospective purchaser, to provide for point-of-sale activation of the products, to provide for subsequent post-activation registration of the products in a secure manner, and to provide methods and apparatus for accomplishing such point-of-sale activation and subsequent registration of the products.

It is an additional object of the present invention to provide a method of manufacture for ensuring accurate association of a serialized product within a package with a point-of-sale activation code on the package.

It is still a further object of the present invention to provide post-purchase delivery of such products over a communications channel, with such delivery being co-ordinated and integrated from manufacture, through point-of-sale activation, and post-purchase registration. It is a further object of the present invention to provide a solution for inventory obsolescence of rapidly evolving data products such as computer software.

### BRIEF DESCRIPTION OF THE SEVERAL VIEWS OF THE DRAWING

FIG. 1 is a plan view of a first embodiment of the package of the present invention before final assembly.

FIG. 2 is a front view of the first embodiment of the package of the present invention after final assembly.

FIG. 3 is a perspective view of the first embodiment of the package of the present invention of FIG. 1 during folding of the panels of the package together.

FIG. 4 is a perspective view of the first embodiment of the package of the present invention of FIG. 1 after folding of the panels of the package together.

FIG. 5 is a rear view of the first embodiment of the package of the present invention after final assembly.

FIG. 6 is an enlarged view of a portion of FIG. 5 of the first embodiment of the package of the present invention, showing the URL designator.

FIG. 7 is a plan view of the joined panels of the package of the first embodiment of the present invention, similar to FIG. 1 but at an earlier stage in assembly.

FIG. 8 is a front view of the transparent window for the computer data storage media of the first embodiment of the package of the present invention.

FIG. 9 is a view of the computer data storage media of the first embodiment of the package of the present invention.

FIG. 10 is a view of the transparent window for a portion of the activation card for the first embodiment of the package of the present invention.

FIG. 11 is a front view of a first embodiment of an activation card of the present invention.

FIG. 12 is a rear view of the first embodiment of the activation card of the present invention.

FIG. 13 is an enlarged rear view of the first embodiment of the activation card of the present invention.

FIG. 14 is a perspective view of an instructional booklet for inclusion within packaging of various embodiments of the apparatus of the present invention.

FIG. 15 is a front view of a transparent window for the computer data storage media of the second embodiment of the package of the present invention.

FIG. 16 is a plan view of the joined panels of the package of the second embodiment of the package of the present invention.

FIG. 17 is a view of the computer data storage media of the second embodiment of the package of the present invention.

FIG. 18 is a perspective view showing placement of an instructional booklet and computer data storage media into a box of the second embodiment of the package of the present invention.

FIG. 19 is a perspective view of the second embodiment of the package of the present invention after final assembly.

FIG. 20 is a perspective view of the second embodiment of the package of the present invention during folding of the panels of the package together.

FIG. 21 is a front view of the second embodiment of the package of the present invention after final assembly.

FIG. 22 is a rear view of the second embodiment of the package of the present invention after final assembly.

FIG. 23 is a plan view of a third embodiment of the package of the present invention before final assembly.

FIG. 24 is a perspective view of the third embodiment of the package of the present invention of FIG. 23 during folding of the panels of the package together.

FIG. 25 is a perspective view of the third embodiment of the package of the present invention of FIG. 23 after folding of the panels of the package together.

FIG. 26 is a front view of the third embodiment of the package of the present invention after final assembly.

FIG. 27 is a rear view of the third embodiment of the package of the present invention after final assembly.

FIG. 28 is a plan view of the joined panels of a fourth embodiment of the package of the present invention.

FIG. 29 is a front view of a second embodiment of an activation card of the present invention.

FIG. 30 is a rear view of the second embodiment of the activation card of the present invention.

FIG. 31 is a plan view of the fourth embodiment of the package of the present invention before final assembly.

FIG. 32 is a rear view of the fourth embodiment of the package of the present invention after final assembly.

FIG. 33 is a front view of a fifth embodiment of the package of the present invention after final assembly.

FIG. 34 is a rear view of a fifth embodiment of the package of the present invention after final assembly.

FIG. 35 is a front view of the sixth embodiment of the package of the present invention after final assembly, whose rear view is shown in FIG. 46.

FIG. 36 is a plan view of an eighth embodiment of the package of the present invention before placement of the activation card in the package during assembly.

FIG. 37 is a front view of the transparent window for the computer data storage media of the eighth embodiment of the package of the present invention.

FIG. 38 is a view of the computer data storage media of the eighth embodiment of the package of the present invention.

FIG. 39 is a front view of a third embodiment of an activation card of the present invention.

FIG. 40 is a rear view of the third embodiment of the activation card of the present invention.

FIG. 41 is a perspective view of the eighth embodiment of the package of the present invention of FIG. 36 during folding of the panels of the package together.

FIG. 42 is a perspective view of the eighth embodiment of the package of the present invention of FIG. 36 after folding of the panels of the package together.

FIG. 43 is a front view of the eighth embodiment of the package of the present invention after final assembly.

FIG. 44 is a rear view of the eighth embodiment of the package of the present invention after final assembly.

FIG. 45 is a perspective view of a ninth embodiment of the package of the present invention with an activation code exposed through an aperture in the package, and with a portion of the package cut away to show an associated PIN inside the package along with computer data storage media.

FIG. 46 is a rear view of the sixth embodiment of the package of the present invention whose front view is shown in FIG. 35.

FIG. 47 is a rear view of a seventh embodiment of the package of the present invention. The front view of the seventh embodiment of the package of the present invention after final assembly is substantially the same as the front view of the sixth embodiment as shown in FIG. 35.

FIG. 48 is a plan view of a substrate of a first embodiment of a label as might be used with some embodiments of the present invention, during an early stage of manufacture of the label.

FIG. 49 is a plan view of the substrate of the first embodiment of the label of FIG. 48 during a subsequent stage of manufacture after printing thereon of a PIN and a machine-readable optical activation code.

FIG. 50 is a plan view of the first embodiment of the label of FIG. 49 during a subsequent stage of manufacture after deposition thereon of an opaque covering over the PIN.

FIG. 50A is a plan view of a second embodiment of the label of FIG. 50, substantially similar thereto except that the machine-readable optical activation code is printed on top of the opaque covering over the PIN.

FIG. 51 is a plan view of the first embodiment of the label of FIG. 50 during removal of the opaque covering over the PIN.

FIG. 51A is a side sectional view of the first and second embodiments of the labels of FIGS. 50 and 50A as applied to a package of the present invention, in which a scratch-off opaque covering has been deposited over the PIN.

FIG. 51B is a side sectional view of a variation of the first and second embodiments of the labels of FIGS. 50 and 50A as applied to a package of the present invention, in which a peel-off opaque covering has been deposited over the PIN and is being removed.

FIG. 52 is a plan view of a third embodiment of a label as might be used with some embodiments of the present invention, having multiple PINs and showing removal of the opaque covering over the multiple PINs.

FIG. 53 is a schematic block diagram showing various components of some embodiments of the method of the present invention.

FIG. 54 is a schematic block diagram showing various components of other embodiments of the method of the present invention.

FIG. 55 is a perspective view of a twelfth embodiment of the package of the present invention during folding of the panels of the package together.

FIG. 56 is a front view of a product registration card for use with the twelfth and thirteenth embodiments of the present invention.

FIG. 57 is a rear view of a product registration card for use with the twelfth and thirteenth embodiments of the present invention.

FIG. 58 is a front view of the transparent window for the multiple product registration cards of the twelfth and thirteenth embodiments of the package of the present invention.

FIG. 59 is a view of the transparent window for a portion of the activation card for the twelfth embodiment of the package of the present invention.

FIG. 60 is a front view of the twelfth embodiment of the package of the present invention after final assembly.

FIG. 61 is a rear view of the twelfth embodiment of the package of the present invention after final assembly.

FIG. 62 is a perspective view of an thirteenth embodiment of the package of the present invention during folding of the panels of the package together.

FIG. 63 is a front view of the thirteenth embodiment of the package of the present invention after final assembly.

FIG. 64 is a rear view of the thirteenth embodiment of the package of the present invention after final assembly.

FIG. 65 is a rear view of a fourteenth embodiment of the package of the present invention after final assembly.

FIG. 66 is a front view of the fourteenth embodiment of the package of the present invention after final assembly.

FIG. 67 is a perspective view of the fourteenth embodiment of the package of the present invention, showing lifting of the protective flap during activation at point-of-sale.

FIG. 68 is a schematic block diagram showing various components of some embodiments of the method of the present invention in which the package is vended from a kiosk at the point-of-sale.

FIG. 69 is a schematic block diagram showing various components of the kiosk shown in FIG. 68.

FIG. 70 is a plan view of a gift box package (fifteenth embodiment) of the present invention, before folding assembly of the gift box package.

FIG. 71 is a perspective view of the gift box package of FIG. 70 during folding assembly of the package.

FIG. 72 is a perspective view of the gift box package of FIG. 70 after folding assembly of the package.

FIG. 73 is a perspective view of the gift box package of FIG. 70 after activation of the product and with the activation card removed.

FIG. 74 is a perspective view of a tenth embodiment of the package of the present invention, similar to the ninth embodiment shown in FIG. 45, with a product serialization code exposed through an aperture in the package and with the label of FIG. 50 applied to the package, and with a portion of the package cut away to show serialized computer data storage media and other product materials inside the package.

FIG. 75 is a perspective view of an eleventh embodiment of the package of the present invention, similar to the ninth embodiment shown in FIG. 45 and the tenth embodiment shown in FIG. 74, with the label of FIG. 50 applied to the package, and with a portion of the package cut away to show unserialized computer data storage media and other product materials inside the package.

FIG. 76 is a diagram showing a portion of a manufacturing step of the present invention in which the activation code and product serialization information are scanned, become associated with each other, and are stored together in a computer database.

### DETAILED DESCRIPTION OF THE INVENTION

Referring to the drawing figures, various preferred embodiments of packaging of the present invention are shown, as well as various preferred methods of practicing the present invention using the preferred embodiments of packaging. FIGS. 53, 54, and 68 show variations of the method of the present invention, and the method of the present invention will be described with only a brief description of the packaging variations used to practice the method of the present invention, followed by a detailed description of the various preferred embodiments of the packaging. It shall be understood that many aspects of all embodiments of the packaging of the present invention are substantially the same, and only the differences will be treated in detail, it being understood that similar structural features of the various embodiments perform similar functions. It should be further understood that variations of the present invention are possible in which some elements of one embodiment's packaging structure are combined with other elements of another embodiment, as will be readily apparent to one skilled in the art after being presented with the disclosure and teachings of the present invention.

Referring to FIGS. 53, 54, and 68, the method of the present invention provides for point of sale activation and subsequent registration of products. The products are able to be presented using a package, generally, 20, in a retail environment in a “cold” or unactivated state and are then “activated” at the time of purchase at a point-of-sale (“POS”). It shall be understood that the terms point-of-sale and point-of-purchase may be used interchangeably herein. The packaged delivery system of the present invention allows a variety of goods and services, generically referred to herein as “products”, to be metered or activated after the product has been purchased. Products suited for this invention include, without limitation, computer software programs, computer software applications, digital information, access to digital information and programming content, “virtual reality” programs and services and games and entertainment, and internet services, all of which require license control or metered access, or where prepayment would benefit a supplier of these products.

It is well-known to purchase such products using credit cards and to deliver such products over a communications channel to a computer's data storage peripherals. Many consumers are unwilling to provide confidential information, such as credit card account numbers or personal data, etc., to unknown organizations or merchants. The present invention offers a method of purchasing products with anonymity and without having established credit.

The product being vended or sold may be activated at the POS by various means. For example, some embodiments of the package have a data-encoded strip with an encoded activation code, and the activation code of the data-encoded strip is read by an appropriate and well-known data-encoded strip reader such as, for example, a well-known magnetic strip reader 22 sold under the trademark VeriFone, or a well-known optical scanner 24 that can read optical characters, bar codes, machine-readable optical recording media, etc., depending on the particular variant of data-encoded strip. Preferably, the activation code may be read at POS without requiring the package to be torn, opened, or destroyed, because such modification of the package would preclude its return to stock in the event that the purchaser decides or is not able to complete the purchase of the product, but modification of the packaging during POS activation, while undesirable, is not precluded by some embodiments of the present invention. As used herein, a “data-encoded strip” shall be understood to mean any of the well-known technologies by which data may be encoded into machine-readable form, such as, for example, by magnetic flux reversals of magnetic media, bar codes, machine-readable optical characters, machine-readable optical recording media, etc. Other embodiments of the package utilize well-known integrated circuit card (“ICC”) technology, also well-known in the trade as so-called “smart card” technology, as described, for example, by the well-known international specifications given in ISO/IEC 7816-3, ISO/IEC 7816-4, ISO/IEC 7816-5, etc., for intelligent payment card technology developed by the international consortium of Europay, MasterCard, and VISA (“EMV”). In such well-known ICC technology embodiments, an ICC element 26, such as an integrated circuit with random access memory (“RAM”) or read-only memory (“ROM”), or both, is programmed with activation code and/or PIN information that can be interrogated, updated, etc., using a well-known ICC interface apparatus 28, and typically the ICC element 26 is embedded into a plastic card. In the context of the present invention, the ICC element may be embedded into an activation card, generally, 78, of the present invention.

All embodiments of the package 20 have at least one PIN, generally, 32, preferably obscured while the package is still in the retail environment for examination by a prospective purchaser, by which the activated product may be registered during a registration step subsequent to activation at POS. The various details of how the PIN may be included with each embodiment of the packaging of the present invention are described with each respective embodiment. The PIN may be alphanumeric data of any desired length, and represents one unique product account in the computer data storage apparatus 34 with which the product is registered after activation. PINs can be produced in a well-known manner by a computer program in random order and of specified alphanumeric character lengths. As hereinafter explained, random PINs can have an associated sequential control number for the vended product, with the relationship and association between the PIN and the control number being established prior to vending of the product, such that the relationship and association may be stored in the computer data storage apparatus 34 prior to vending of the product. So as to enable a one-to-one mapping between the number of product accounts, i.e., sequential control numbers, and the PINs, the PINs will be of an appropriate length to enable such unique encoding. Additionally, the PIN may be lengthened by adding additional alphanumeric characters (check codes) for additional levels of security. If desired, the control number may be encoded in the data-encoded strip or ICC element, etc., and this encoding of the control number may be used as an additional security check for the PIN.

For ease of use by a person registering the product, the PIN, if human readable, may have dashes or spaces interposed within the alphanumeric characters, such as, for example, 999-999-999 or 999 999 999.

As described in greater detail herein as the various embodiments are presented, the PIN or PINs may be obscured by panels of the package or by a removable opaque covering such as well-known scratch-off opaque material or peel-off opaque material, so as to provide an additional level of security by providing the customer with evidence of surreptitious viewing and/or tampering prior to purchase. If the obscuring material were to show evidence of tampering, the customer would realize that the PIN or PINs were no longer secure. The well-known opaque scratch-off material can be deposited over the PIN by heat and pressure using commonly-available hot stamping material, or could be printed in a slurry or screen-printed directly over the PIN so as to provide security. The opaque material may be overprinted with instructions to remove the obscuring material in order to access the PIN. A pressure-sensitive opaque label may be positioned over the PIN or PINs using an appropriate applicator in an automated machine process at high speeds. An opaque pressure-sensitive permanent-adhesive label, cut or scored to allow evidence of tampering, could be used to secure and conceal the PIN, and instructional information may be provided with instructions describing to the purchaser how to notice evidence of tampering with the PIN or any data under the label.

The package of the present invention may be of various sizes and shapes, and may, if desired, have a well-known hanger-hole aperture, generally, 36, allowing the package to be hung from a product display hook in the retail environment prior to sale. Alternatively, the package may be placed in display containers or on racks in the retail environment. If desired, some or all of the surface of the package may be used for providing graphics for advertising or product information, in a manner well-known to those skilled in the art. The fact that the package of the present invention allows unactivated product to be openly presented and displayed in the retail environment due to the POS activation of the product permits POS graphics that present and describe the product to a prospective consumer so as to encourage sale of the product, in contrast to prior art pre-activated products that necessarily had to be hidden or locked securely away at retail outlets to discourage theft. Accordingly, the package of the present invention becomes a communication billboard that presents graphic, visual, and informational text to the consumer, and may communicate product features, benefits, and loyalty-branded coupons to the marketplace.

In some preferred embodiments of the method of the present invention, the activation code is transmitted over a first communications channel 38 from the POS to computer data storage apparatus 34. Upon receipt of the activation code by the computer data storage apparatus 34, it then, by the stored association within computer data storage apparatus 34 between the activation code and the PIN, records that the PIN for the purchased product has been activated and may then be used to register the purchased product. In other preferred embodiments of the present invention, such as, for example, an embodiment having a kiosk at the POS, the PINs may supplied over the first communications channel 38 by the computer data storage apparatus 34 to the kiosk at the time of product purchase and then placed on the package by the kiosk at the time of vending the package at purchase, in a manner hereinafter described, and the computer data storage apparatus would record that the supplied PIN has been activated and may be used for subsequent registration of the purchased product.

It should be understood that computer data storage apparatus 34 may be of a well-known distributed processing computer architecture and need not be completely located at a single centralized location. For example, the POS activation and communication over the first communications channel 38 may be to a well-known specialized “front end” processor 40, which may be considered a portion of a distributed computer data storage apparatus 34, such that front-end processor 40 communicates using specialized protocols with the particular POS activation device, such as well-known magnetic strip reader 22, well-known optical scanner 24, well-known ICC interface apparatus 28, kiosk computer 42, etc. In turn, the receipt of the activation code by computer data storage apparatus 34 may cause recording at another physical site of the fact that the supplied PIN has been activated and may be used for subsequent registration of the product. By such a distributed architecture for computer data storage apparatus 34, communication with the POS may occur from one physical location while subsequent registration of the product may occur by communication with a different physical location, e.g., with a registration or authorization verification entity such as the product's manufacturer, to whom information has been provided that the product has been purchased and may be registered. Once the product has been activated, the product may be consumed as by downloading or delivering information, software files, programs, unlocking codes, etc., so that the purchased product may be used, and the providing of downloaded product may be over still another communications channel from perhaps still another physical location.

Subsequent to POS activation, the purchased product is registered over a second communications channel 44, during which registration step the now-activated PIN is supplied to computer data storage apparatus 34, perhaps also with other related registration information, and the computer data storage apparatus 34 will then, after verifying that the PIN has been activated and may be used to register the product, enable use of, or delivery of, all or a portion of the purchased product. Optionally, the user may receive an “unlocking code,” etc., from the computer data storage apparatus 34 for subsequent use at the time the product is accessed or used, thereby permitting use of the product or service, and, for some types of products/services, such as, for example, computer software products, updates or revisions, or perhaps even the entire product, are then downloaded over the communications channel 44 (or perhaps even a different communications channel than the one used for registration). In some embodiments of the present invention, the registration and optional receipt of an unlocking code, as well as the optional downloading over the communications channel of updates or part or all of the product, may be automated, occurring at the first use of the product's computer data storage media without explicit request by the user.

In a distributed architecture for computer data storage apparatus 34, registration communication over the second communications channel 44 may be to a well-known specialized “front end” processor 48, which may be considered a portion of a distributed computer data storage apparatus 34, such that front-end processor 48 communicates using specialized protocols with a user's computer 50, and processor 48 may perform validation and registration itself as a distributed portion of computer data storage apparatus 34, or may communicate with another distributed portion of computer data storage apparatus 34 that may do the validation and registration.

Various implementations of communications channels 38, 44 are well-known to those skilled in the art, and their detailed implementation is unnecessary for an understanding of the present invention. If desired, communications channel interface devices 46, such as well-known “modems” or the like, may be used to modulate and demodulate data onto the communications channels.

As shown in FIG. 54, computer data storage apparatus 34 may be interfaced to second communications channel 44 using well-known audio recognition means 52 for recognizing a PIN transmitted using an audio signal over communications channel 44 by the user, and the step of product registration for these embodiments of the method of the present invention includes the steps of providing a well-known telephone 54, establishing a telephonic connection between telephone 54 and audio recognition means 52 over communications channel 44, and transmitting the PIN to the audio recognition means 52 using the telephone 54. For example, audio recognition means 52 may be a well-known telephonic dialing tones recognizer for recognizing the audio dialing tones emitted by well-known audio tone generation means 56 of a well-known tone-dialing telephone 54, and the step of transmitting the PIN over communications channel 44 would include the steps of causing the audio tone generation means 56 of telephone 54 to generate a sequence of telephonic dialing tones that represent the alphanumeric PIN, and recognition of that sequence of telephonic dialing tones by the telephonic dialing tones recognizer 52, which would then pass the PIN data on to computer data storage apparatus 34 for verification and registration. Alternatively, audio recognition means 52 may be a well-known integrated voice recognition (“IVR”) apparatus that can recognize a vocabulary of spoken words, and the step of transmitting the PIN over the communications channel 44 would include the steps of causing the PIN to be spoken into the handset 58 of telephone 54, followed by recognition of the spoken PIN by the IVR 52. It is well-known for such IVR apparatus to include prerecorded messages or computer speech generation means so that messages and instructions may be provided to the caller. As another alternative, the telephone connection may be made to a “call center” with human customer service representatives, who would audibly receive a spoken PIN from the user and manually perform the registration step, perhaps supplying a spoken unlocking code for the product to the user.

In order to establish the telephone connection to the audio recognition means 52 at product registration, the package 20 of the present invention will preferably include a telephone number 59 printed thereon or within included materials in the package, in a manner hereinafter described.

Alternatively, rather than having the user establish a voice telephone connection during product registration, and as shown, for example the package 20 may include a well-known so-called “web address” or internet “URL” (Uniform Resource Locator) 60, a human-readable name used to locate a file or machine on the internet, optionally specifying the protocol (e.g., http, ftp), the machine, an optional path on the machine, and an optional (but rarely used) protocol port number, such as, for example, the URL of “www.riverborne.com”. The user, at registration, would simply run any of the well-known internet browsing communications programs (so-called internet “browsers”) on his or her computer 50, provide the URL 60 to the communications program, and have the communications program establish a connection over the internet to the computer data storage apparatus 34. Registration would then proceed using the browser and having the user provide registration information over the internet to the computer data storage apparatus 34. If desired, auxiliary registration data, such as a user's telephone number, name, postal address, Social Security number, email address, a user-selected password, etc., may be provided during registration, and the computer data storage apparatus 34 may record this auxiliary registration data and associate it with the PIN provided at registration, thereby permitting the provided user's telephone number or email address or password, etc., to be used instead of the PIN to access the purchased product subsequent to registration, or thereby permitting postal mailings or electronic mailings to be made to the now-registered user, etc., or to permit the user to accrue “loyalty points” or to obtain additional value incentives.

Still alternatively, the PIN may be machine readable as by a computer interface, and a PIN-reading apparatus may be provided and attached to the user's computer 50 so that the user is not required, or perhaps even permitted, to manually enter the PIN during registration of the product, and the PIN may be read under computer program control by the provided PIN-reading apparatus and transmitted to the computer data storage apparatus 34 over the second communications channel 44. For example, some embodiments of the package have a data-encoded strip for the PIN with the PIN being encoded into the data-encoded strip, and the PIN is read from this data-encoded strip by an appropriate and well-known data-encoded strip reader such as, for example, a well-known magnetic strip reader 22, or a well-known optical scanner 24 that can read optical characters, bar codes, machine-readable optical recording media, etc., depending on the particular variant of data-encoded strip. The PIN-reading apparatus may be of similar or identical construction as the activation code reader used at POS. Alternatively, the PIN may be encoded onto computer data storage media, generally, 62, for reading by an appropriate computer data storage media reader 64, or the PIN may be encoded within an ICC element 26 within the purchased package and readable only using a well-known ICC interface apparatus 28. It shall be understood that the term “computer data storage media”, as used herein, shall be interpreted to mean any of the many and various media on which computers may store and/or retrieve data, such as, for example, read-only memory (“ROM”), random-access memory (“RAM”), compact disc (“CD”) ROMs, magnetic or optical computer data storage media, computer disk drives, “floppy” disks, removable storage media, cassette tapes, etc.

It should be understood that multiple technologies may be simultaneously used to encode either or both of the activation code and PIN, so as to permit, for example, a POS with one technology but not another of an activation code reader to activate the package, without having to co-ordinate particular embodiments of the present invention with the particular (or unknown) technology at a given retail environment, or to allow the same package to be sold to a variety of customers, some having home computers and others lacking home computers, etc.

If an embodiment of the present invention is used whereby the user's computer can read information from the purchased package 20 or from a portion of the package and/or from contents within the package, then the registration process can be automated. For example, an “autostart” CD-ROM, or other computer-readable media or an ICC element, etc., having the URL and/or PIN encoded therein, could, under computer program control, initiate direct contact with computer data storage apparatus 34 at the internet address given in the URL, and provide the necessary registration information such as one or more PINs, activate the product's PIN or PINs, receive partial or full updated versions of the product, and/or receive one or more unlocking codes from computer data storage apparatus 34, all with or without any interaction from the user. If desired, the user could be prompted to provide additional auxiliary registration information, as heretofore discussed. Additionally, the registration process could provide the computer data storage apparatus 34 with information unique to the user's computer, such as, for example, the network hardware interface address (“MAC address”), etc., so as to restrict transfer of the registered product to another computer, or to provide information to be used during future customer service and/or technical support requests, as well as to limit or meter the future use of the product.

If an embodiment of the invention is chosen that has an ICC element 26, then such an ICC card may then be used, in a manner well-known to those skilled in the art, to validate authentication of the card holder during subsequent product utilization, software download, activation code retrieval, etc. Such an authenticated ICC card could also be used for providing an access key to pay-per-use entertainment programming, entertainment services, virtual reality software games, educational material or instructional classes, and any other electronically-delivered product requiring a fee or license or pre-purchase. Other types of products that could be used or accessed by such an authentication ICC card are special entertainment or sporting events, entertainment products, streaming video or audio, music or concerts, or any products available through a computer with use of a valid ICC card and an appropriate ICC card reader, with the ICC element being activated by the present invention at POS or during registration.

Referring to the drawing figures, the various embodiments of the packaging of the present invention will now be described in detail. Identifying reference designators for all preferred embodiments of the packaging are marked similarly except using prefix designators of “1.”, “2.”, etc., for the respective first, second, etc., preferred embodiments.

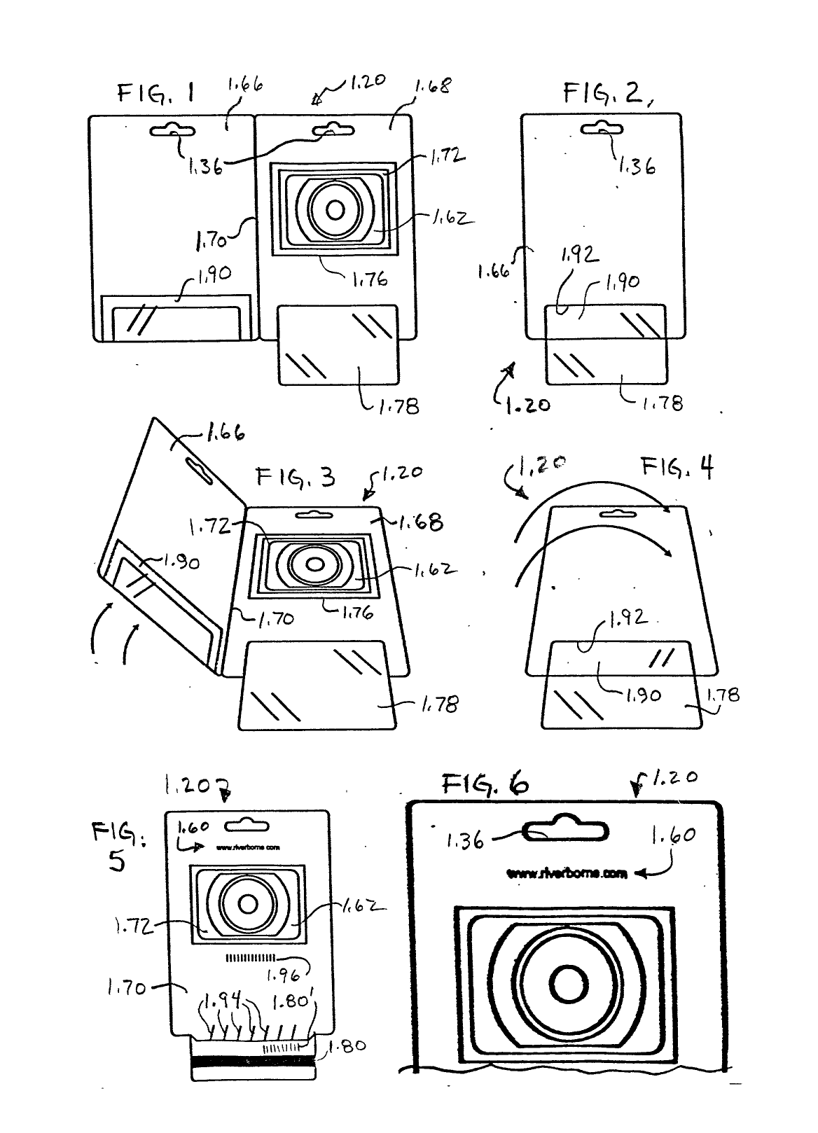

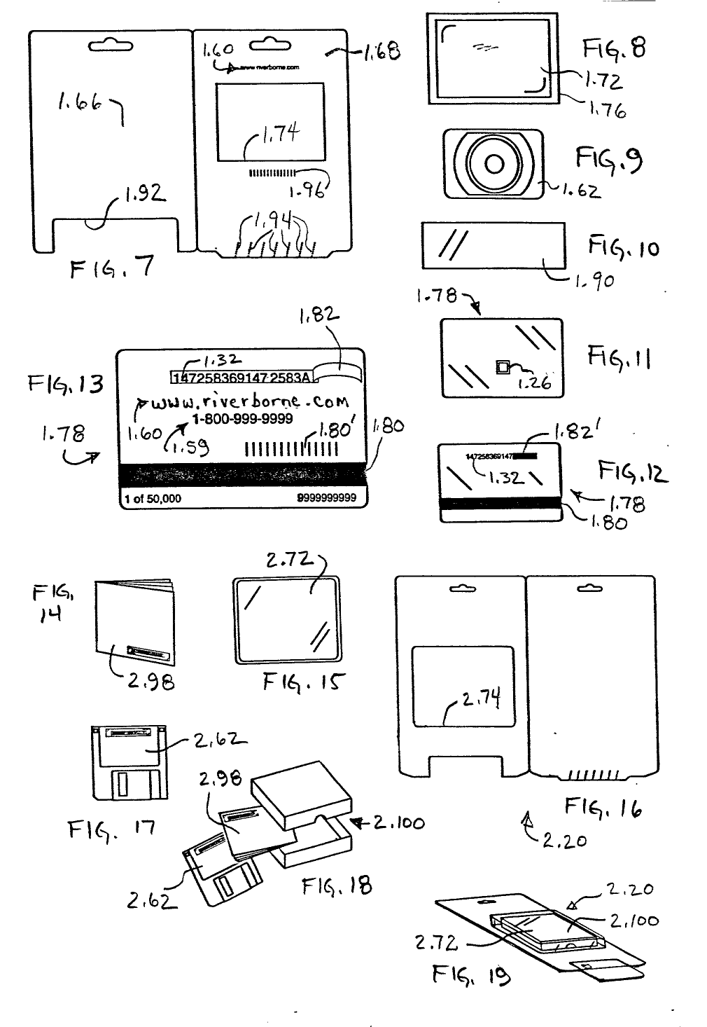

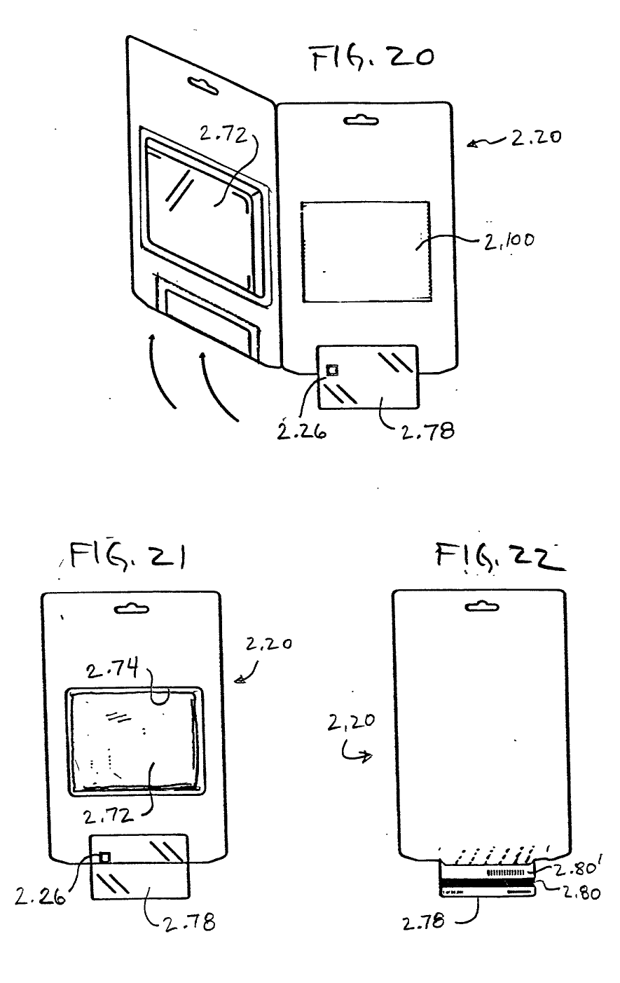

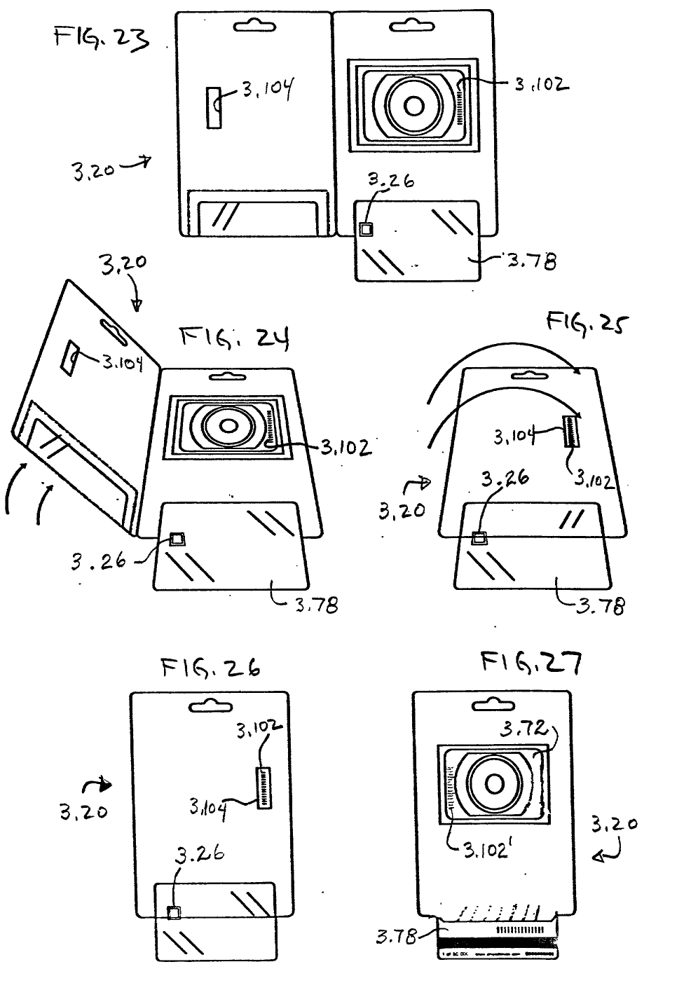

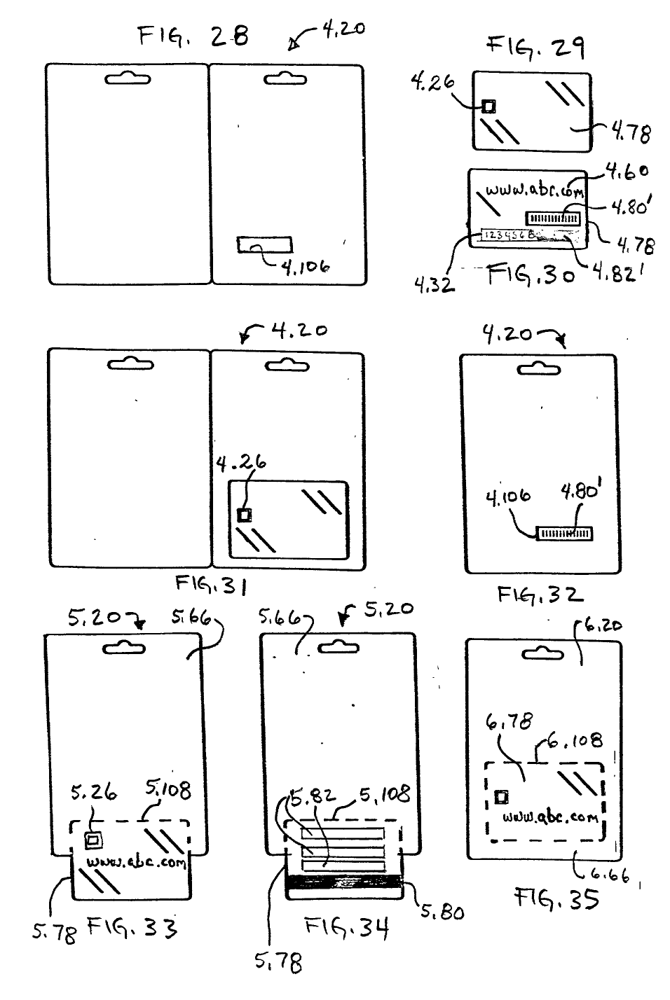

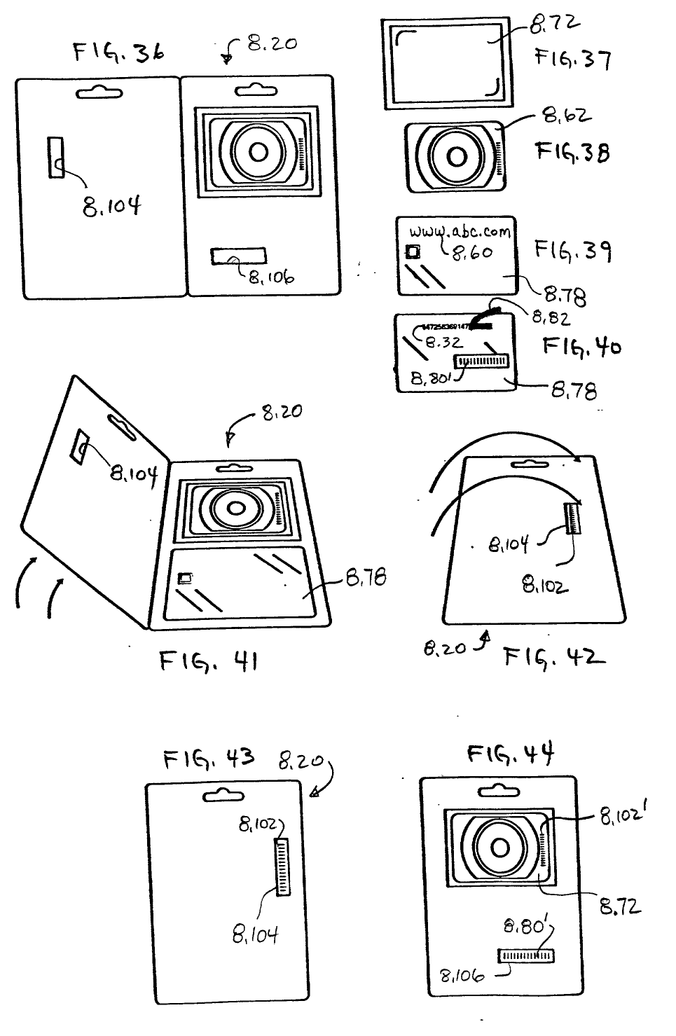

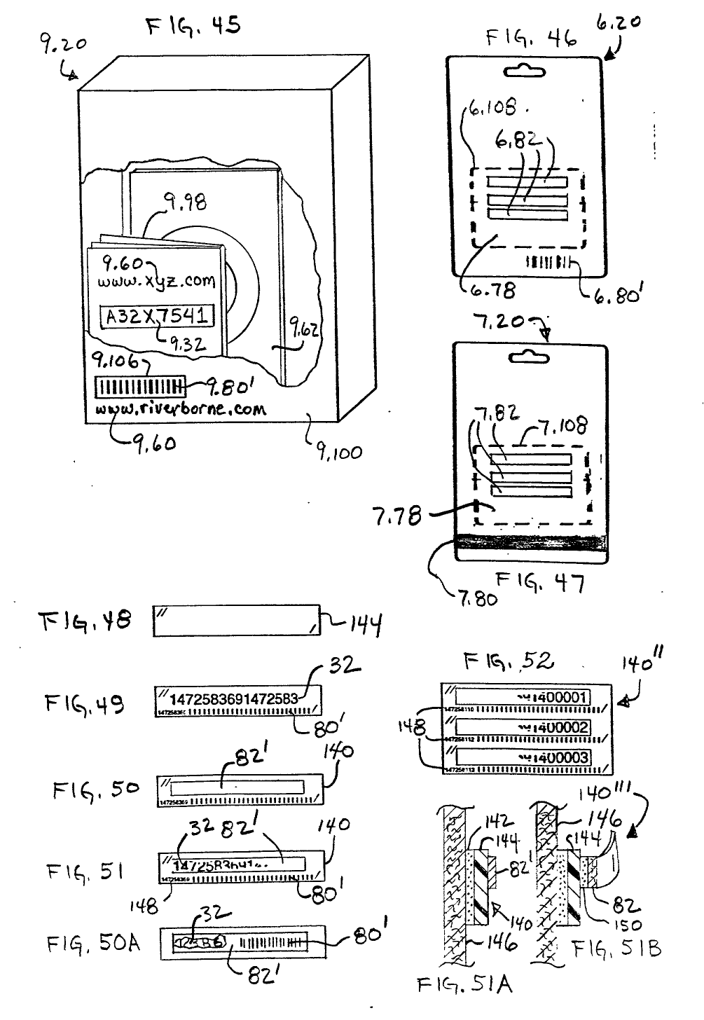

FIGS. 1-10 show a first preferred embodiment 1.20 of the package of the present invention. Package 1.20 has first and second panels 1.66 and 1.68 preferably constructed from a single piece of well-known one or two ply paper or plastic material and being optionally hingeably joined along a hinge line 1.70, and after folding the panels together, they are preferably secured in place to each other by well-known heat-activated PVC coating or other pressure-sensitive hot-melt adhesive on the panels, and certain areas of the panels may be masked out with no PVC coating thereon applied, in a manner well-known to those skilled in the art.

Computer data storage media 1.62, such as a well-known CD-ROM, is retained within package 1.20 by a transparent plastic blister window 1.72 that is received within a product display aperture 1.74, with blister window 1.72 being sandwichingly retained between the panels by a peripheral flange 1.76 around blister window 1.72. As the package 1.20 is sealed, preferably using a PVC-based heat-activated adhesive as hereinafter described, the blister flange 1.76 will be sandwichingly sealed to the panels of the package. Alternatively, blister window 1.72 may be joined to a panel of the package using a radio-frequency sealer to bond the blister flange 1.76 to the surface of the package.

Package 1.20 includes an activation card 1.78, as may be seen in greater detail in FIGS. 11-13, secured to package 1.20 preferably by a high shear strength, low peel strength adhesive such as PVC-based heat-activated adhesive applied to a portion of or all of the inside surfaces of the panels of the package 1.20. An example of such a construction is taught by Hansen, U.S. Pat. No. 5,791,474 (issued Aug. 11, 1998), hereby fully included herein by reference. Activation card 1.78 has a magnetic data-encoded strip 1.80, well-known to those skilled in the art and readily readable by a well-known magnetic strip reader 22, onto which the activation code has been encoded, as herein described. Activation card 1.78 may have a PIN 1.32 thereon obscured by a removable opaque covering such as a well-known peel-off opaque label 1.82 (shown being removed in FIG. 13) or a well-known scratch-off opaque covering 1.82′ (shown being removed in FIG. 12). Activation card 1.78 may have a URL 1.60 thereon, directing the user to an internet address at which the product may be registered, and also may have a telephone number 1.59 thereon, directing the user to a telephone connection at which the product may be registered by speaking the PIN 1.32 into a telephone or by entering a sequence of telephone dialing tones, as herein described in the present invention's preferred embodiments of the steps of registration. The activation card 1.78 may also have a machine-readable optical data-encoded activation strip 1.80′, and one of the panels of the package 1.20 may have the PIN 1.32 printed thereon and hidden by the sandwiched assembly of the panels. Preferably, activation card 1.78 has a portion thereof extending outside the perimeter of at least one of the panels of the package 1.20 as seen best in FIG. 5 so that the magnetic data-encoded activation strip 1.80 and/or the optical data-encoded activation strip 1.80 may be read at the POS without having to remove the activation card 1.78 from the package 1.20 during POS activation. If desired, activation card 1.78 may have a well-known ICC element 1.26 embedded therein, into which the PIN and/or activation code may be stored, as heretofore described. FIGS. 65-67 show a fourteenth embodiment 14.20 of the present invention, similar to the first embodiment 1.20, except that a protective flap 14.84 extends over the activation strip 14.80 of the activation card 14.78 of the fourteenth embodiment prior to activation, and the protective flap 14.84 is folded or bent along a fold, cut score or perforation 14.86 prior to activation so as to expose the activation strip 14.80.

Returning to the first embodiment 1.20, a transparent protective Mylar plastic or film window 1.90 may be provided for covering a cutout 1.92 in one of the panels of package 1.20, so that graphics and text on activation card 1.78 may be seen through transparent window 1.90 after assembly has been completed of package 1.20, with transparent window 1.90 being preferably adhered to the package 1.20 during its sandwiched construction because the dimensions of transparent window 1.90 are greater than those of cutout 1.92.

Preferably, one of the panels of package 1.20 may have a plurality of perforated scores or cut lines 1.94 along an edge over the activation card 1.78 so as to permit easier release of activation card 1.78 from the rest of package 1.20 after purchase, and also to provide tamper evidence of an attempt to view the PIN 1.32 on activation card 1.78 prior to purchase. Alternatively or additionally, package 1.20 may have an optically-readable bar code or alphanumeric code or optical data-encoded strip 1.96 that may be used for encoding the PIN, the activation code, or product serialization information onto the package. If desired, the URL 1.60 for connection to the registration computer may also, or alternatively, be printed on one or both of the panels of package 1.20. If desired, package 1.20 may have a well-known hanger-hole aperture 1.36 allowing the package to be hung from a product display hook in the retail environment prior to sale.

FIGS. 14-22 show a second embodiment 2.20 of the packaging of the present invention, similar to the first embodiment 1.20 except that the computer data storage media 2.62 is a well-known “floppy disk” having magnetic data storage media rather than the optical data storage media of the first embodiment. Floppy disk 2.62 may be placed together with an instructional book 2.98 within a product box 2.100, and box 2.100 is then retained within package 2.20 by a transparent window 2.72 that is received within a product display aperture 2.74 within one of the panels of package 2.20. Various items may be placed within box 2.100 such as, for example, printed collateral materials such as a map, an audio or data CD-ROM, greeting cards, game-related toys, and/or coupons. If desired, the box 2.100 may have one or more apertures therethrough to allow scanning of serialized product codes, activation codes, etc. As with the first embodiment, an activation card 2.78 has a magnetic data-encoded strip 2.80 or an optical data-encoded strip 2.80′ exposed and extending beyond the perimeter of one of the panels of package 2.20, and activation card 2.78 may include an ICC element 2.26.

FIGS. 23-27 show a third embodiment 3.20 of the packaging of the present invention. The substantial difference between the first and third embodiments is that, with the third embodiment, a product serialization code 3.102 shows through a product serialization aperture 3.104 in a panel of the package 3.20 such that the product serialization code 3.102 may be viewed after the product is assembled. As hereinafter explained, such a structural feature can enable the finished package to be scanned during manufacture as a quality control step, either to verify that the correct serialized product has been matched with a given activation code, or else, and preferably, for the manufacturing process to scan both the activation code and the product serialization code and make an association between the two so that this association between the two may be passed to the computer data storage apparatus 34 for use at the time of product registration, and also for preparing quality control and inventory tracking reports. As with other embodiments, an activation card 3.78 may have an ICC element 3.26, if desired. Alternatively, or additionally, a product serialization code 3.102′ may show through the transparent blister window 3.72 as seen in FIG. 27, or, if an opaque and non-transparent blister window 3.72 is used, an aperture (not shown) may be provided through the retaining blister 3.72 for viewing the product serialization code 3.102′.

A fourth embodiment 4.20 of the packaging of the present invention is shown in FIGS. 28-32. The fourth embodiment is similar to the first embodiment except that, in the fourth embodiment 4.20, the activation card 4.78 is contained within the perimeter of the panels of the package 4.20 rather than having a portion of the activation card extend outside that perimeter, and an activation code 4.80′ on the activation card 4.78 shows through an activation code aperture 4.106 in one of the panels of the package 4.20. As with other embodiments, the activation card 4.78 may have an ICC element 4.26 embedded therein, and activation card 4.78 may have a URL 4.60 and may have a PIN 4.32 that may be obscured by an opaque covering such as scratch-off opaque covering 4.82′.

As with all embodiments, the choice of adhesive used to seal the panels of the package together and/or to secure the various components of the package (panels, computer media, activation card, instructional booklets, etc.) together will be determined by the residue remaining on, or any damage to, any components of the package, as well as the holding strength of the adhesive, in a manner well-known to those skilled in the art. A preferred adhesive, for effective adhesion, efficient application, and adequate shear strength is well-known pressure-sensitive hot-melt adhesive, readily available in the market and having little residual effect on components of and within the package. Likewise, single or double-sided tape may be used to attach components to the package, and the kind of tape, and/or the adhesive on the tape, can similarly be determined by the residue remaining on or damage to any component after being removed from the package of the invention. Included in the design choice of tape and its type are the application properties of the particular tape and its associated costs. Tape may overlay and extend beyond the perimeter of an assembled component and adhere to any required portion of the package. A pressure-sensitive label with a heat-activated PVC coating may be used to attach the activation card, or any other component of the packaging or of the product, to the package, and such a pressure-sensitive label may extend beyond the perimeter of the activation card or component, if desired.

A fifth preferred embodiment 5.20 of the packaging is shown in FIGS. 33-34. Different from the first embodiment, the fifth embodiment uses a package 5.20 preferably of a one-piece construction, preferably a plastic package, and the activation card 5.78 is secured to the panel 5.66 of the package by perforations 5.108. Like other embodiments, activation card 5.78 may have an ICC element 5.26 embedded therewithin, and package 5.20 may have a magnetic activation strip 5.80 and one or more obscured PINs that are obscured by an opaque covering 5.82.

A sixth embodiment 6.20 is shown in FIGS. 35 and 46, and the rear of a seventh embodiment 7.20 is shown in FIG. 47, it being understood that the front of the seventh embodiment 7.20 is substantially the same as the front of sixth embodiment 6.20 as shown in FIG. 35. The substantial difference between the fifth embodiment 5.20 and the sixth embodiment 6.20 is that, with the sixth embodiment, the activation card 6.78 is wholly within the perimeter of the panel 6.66 of the package 6.20, and perforations 6.108 allow removal of the activation card from the package. Activation card 6.78 has a plurality of PINs thereon that are obscured by an opaque covering 6.82, and activation card 7.78 likewise has a plurality of PINs thereon obscured by an opaque covering 7.82. The substantial difference between the sixth and seventh embodiments is that the sixth embodiment shows an optical data-encoded activation strip 6.80′ on the panel of the package outside the perimeter of the activation card 6.78, whereas the seventh embodiment shows a magnetic data-encoded activation strip 7.80 on the panel of the package outside the perimeter of the activation card 7.78.

An eighth embodiment 8.20 is shown in FIGS. 36-44, with similarities to the third and fourth embodiments. The activation card 8.78 is similar to the activation card 4.78 except, in order to show different possibilities for the activation card, activation card 8.78 shows different placement of the URL 8.60 and the PIN 8.32 is obscured by a peel-off opaque covering 8.82. Transparent window 8.72 and computer media 8.62 are substantially similar to transparent window 3.72 and computer media 3.62. Like the fourth embodiment, activation code 8.80′ shows through an activation code aperture 8.106 and, like the third embodiment, a product serialization code 8.102 shows through a product serialization aperture 8.104 and a product serialization code 8.102′ may also show through the transparent window 8.72.

FIGS. 45, 74, and 75 show similar ninth, tenth, and eleventh embodiments 9.20, 10.20, and 11.20. In all of these embodiments, an instructional booklet 9.98, 10.98, and 11.98, respectively, may be within the box 9.100, 10.100, and 11.100, respectively, and all may contain computer data storage media 9.62, 10.62, and 11.62, respectively. In embodiment 9.20, instructional booklet 9.98 serves a similar purpose as the activation card of other prior embodiments, and box 9.100 and/or instructional booklet 9.98 may have a URL 9.60 for use in performing registration of the product. In embodiment 9.20, a PIN 9.32 is included within the package as on instructional booklet 9.98, for example, and, because it is sealed within the package, there is no need for obscuring of the PIN, although such an obscuring covering may be provided, if desired. Additionally, the embodiment of package 9.20 has an activation code 9.80′ visible on the outside of the package, either by having the activation code 9.80′ be printed on or affixed to the outside of box 9.100, or preferably by having activation code 9.80′ be printed on or affixed to contents within the package and show through an activation code aperture 9.106 in box 9.100.

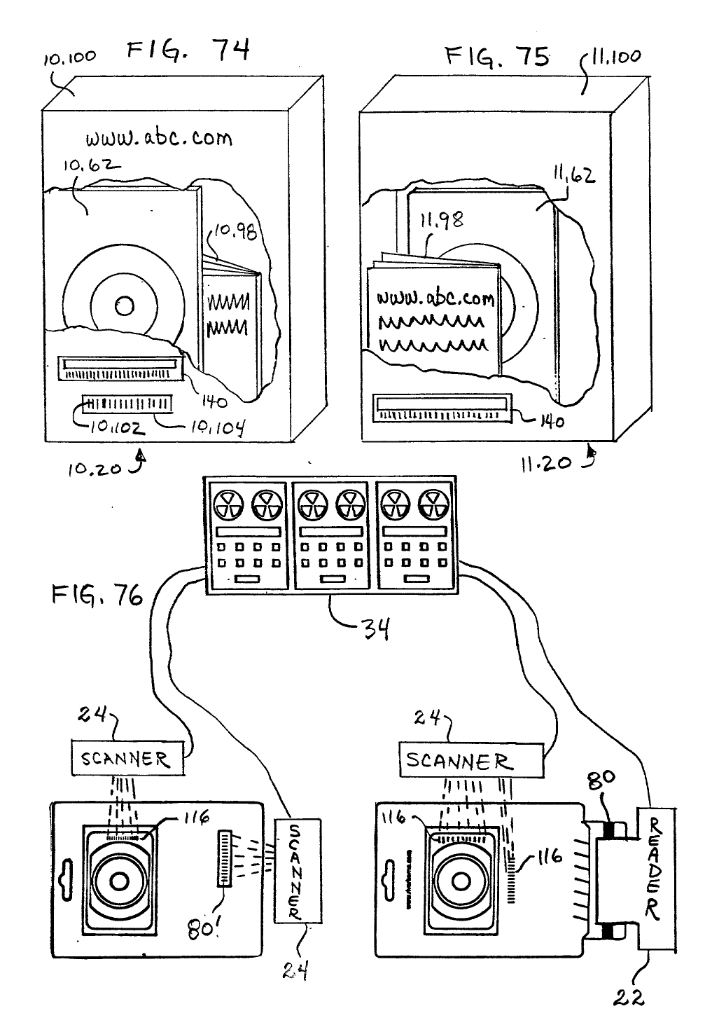

The tenth embodiment 10.20 of FIG. 74 is similar to the ninth embodiment except that a product serialization code 10.102 is exposed through a serialization code aperture 10.104 through box 10.100, and has a label 140 of FIG. 50, hereinafter described, applied to the surface of the box 10.100. The eleventh embodiment 11.20 of FIG. 75 is similar, except the contents within box 11.100 are unserialized, and a label 140 of FIG. 50, hereinafter described, is affixed to the outside of the box 11.100 so as to provide both the activation code and the PIN on the label 140 after sealing the box 11.100 during manufacturing.

FIGS. 48, 49, 50, 51, and 51A show first embodiment 140 of a label of the present invention that facilitates applying the PIN and activation code to a package. The label 140 has a well-known pressure-sensitive adhesive 142 on the rear surface of its substrate 144, and may be applied to a package surface 146 from a roll of labels using a well-known so-called “blow-on” label applicator such as a pneumatic label applicator, followed by pressure being applied to the label, after placement on the package surface 146, using a well-known label tamping device so as to cause the label to be securely adhered to the package surface 146. A PIN 32 is printed on top of the label's substrate 144, and an obscuring removable opaque covering, such as scratch-off covering 82′, is applied over the PIN 32 to the substrate so as to obscure the PIN 32. FIG. 50 shows the completed label with obscuring covering 82′ over the PIN, and shows an activation code 80′ on the label as well. If desired, other serialization or product code information 148 may be printed on the label as well. By using such a label to practice the present invention, the activation code(s) and PIN(s) may be applied to the package in a single step from a roll of labels using a label applicator, with the correspondence between the PINs and the activation codes having been established during the manufacture of the labels rather than after placement of activation codes and PINs with the packaging, thereby enabling manufacture of the product to be separated from the activation code and PIN correspondence and tracking.

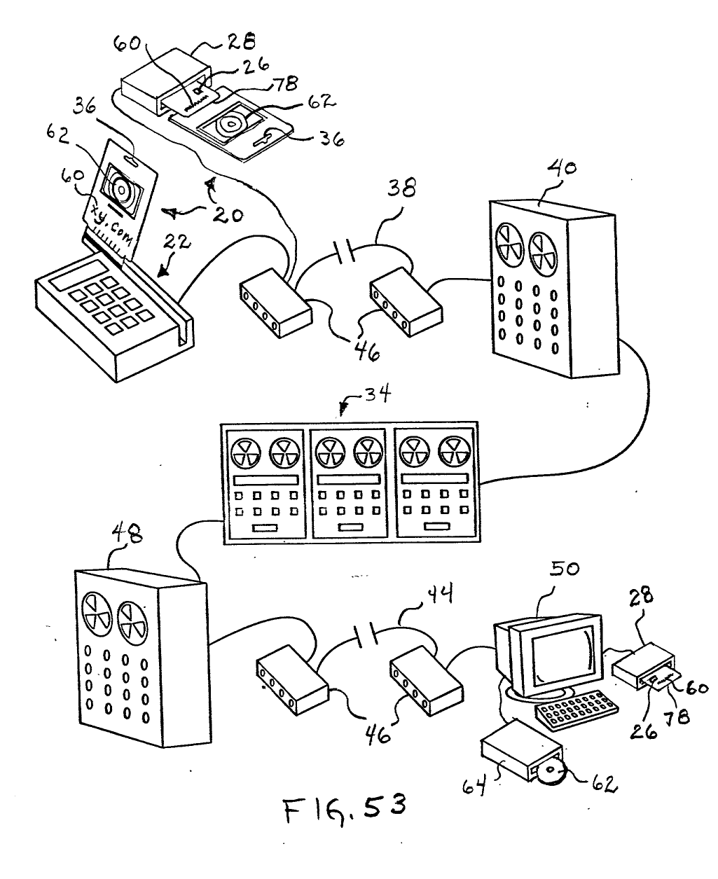

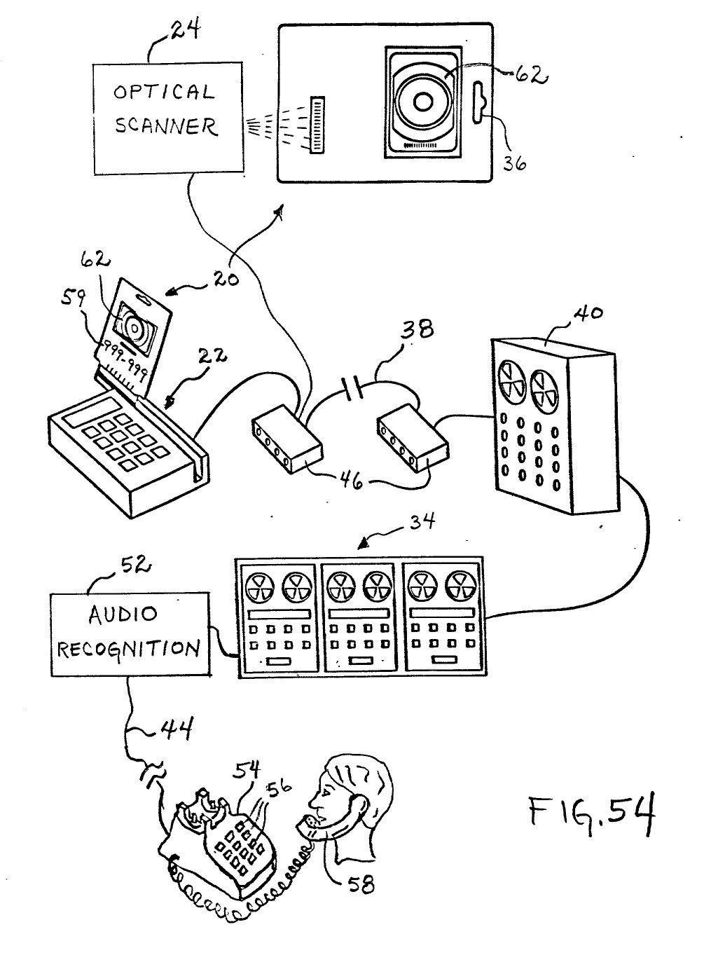

FIG. 50A shows a variant 140′ of the label 140 in which the activation code 80′ is printed on top of the obscuring removable opaque covering 82′. FIG. 52 shows a variant 140″ of the label 140 in which a plurality of PINs are obscured by a plurality of obscuring opaque coverings. The structure of label 140″ is otherwise substantially the same as label 140, and it shall be understood that the activation codes of FIG. 52 may be overprinted on the plurality of obscuring opaque coverings as well. The label 140′″ of FIG. 51B is similar to that of FIG. 51A, except that a peel-off removable opaque covering 82, having a releasable adhesive 150 affixing covering 82 to substrate 144, is used rather than a scratch-off covering, and it shall be understood that the activation code may be overprinted onto covering 82 as well.

It shall be understood that any of the package embodiments of the present invention, not only the box of FIG. 75, could preferably use the labels 140, 140′, 140″, 140′″ of the present invention, or could instead have the activation code and/or PIN printed on the package or a component of the package. Use of the labels of the present invention separates manufacture of the product package from the activation code.

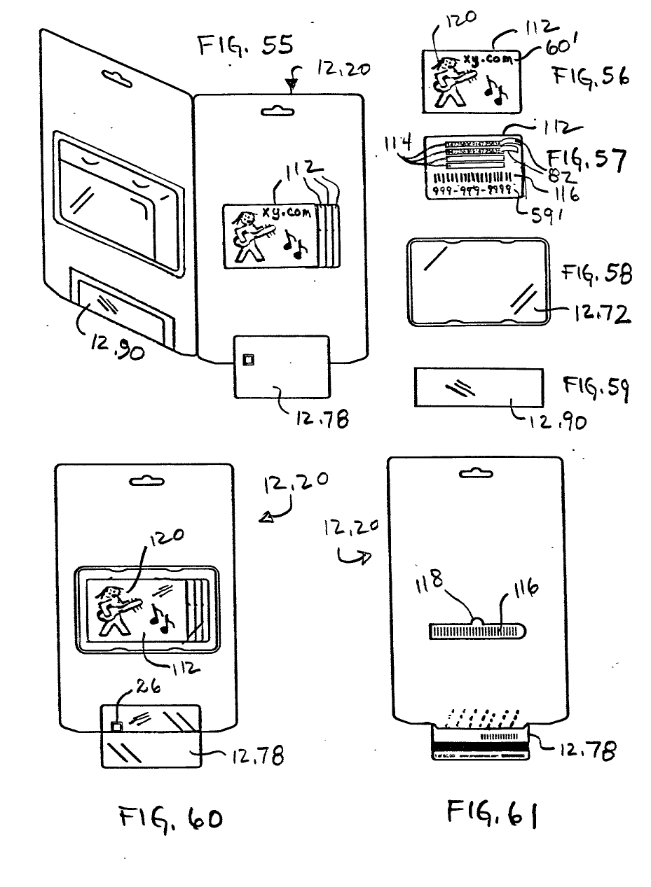

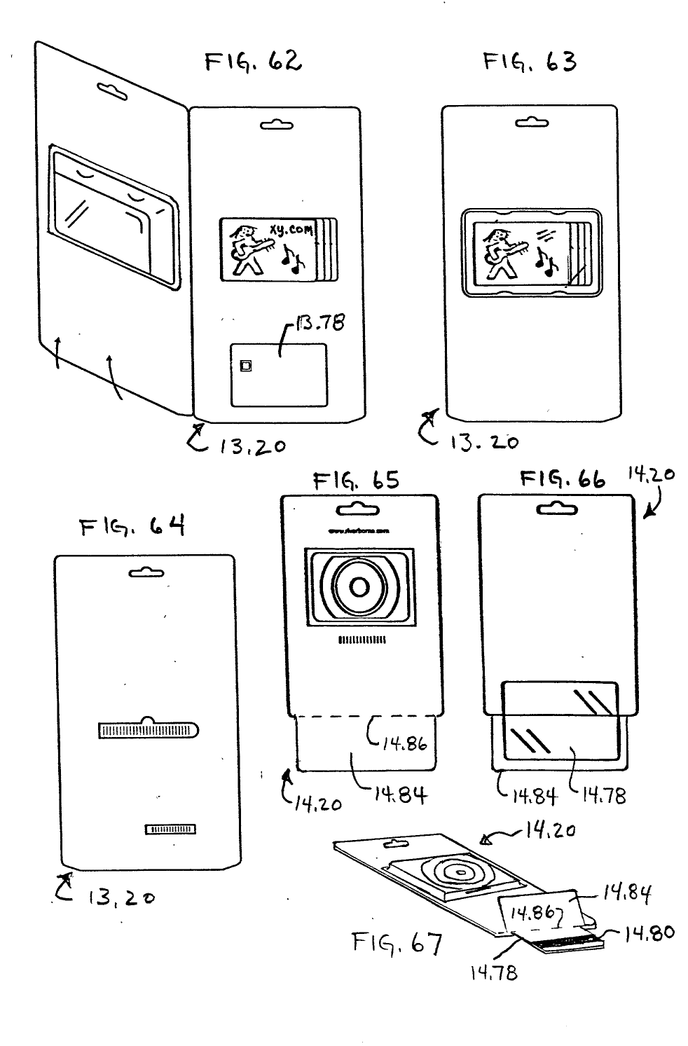

FIGS. 55-61 show a twelfth embodiment 12.20 of the present invention, and FIGS. 62-64 show a similar thirteenth embodiment of the present invention, it being understood that the substantial difference between the twelfth and thirteenth embodiments is the structure of the placement of the activation cards 12.78 and 13.78 on the package. Twelfth embodiment 12.20 uses an activation card 12.78 that is substantially similar to activation card 1.78 of the first embodiment, and that description need not be repeated here, and a transparent window 12.90 may be used to show a portion of activation card 12.78 therethrough. Thirteenth embodiment 13.20 uses an activation card 13.78 that is similar to the activation card 4.78 of the fourth embodiment 4.20, and that description need not be repeated here. Otherwise, the twelfth and thirteenth embodiments of the present invention are substantially the same, and a description of the twelfth embodiment will suffice for both.

Package 12.20 holds a plurality of product registration cards 112, each having a product registration code 114 thereon. The product registration cards 112 are retained within a blister window 12.72, similar to the blister windows of other embodiments, and a serialization code 116 for one of the product registration cards 112 shows through a product serialization aperture 118 in the package. As with the PINs of other embodiments, the product registration code 82 for each registration card 112 may be obscured by obscuring removable opaque coverings 82. During manufacture, all serialization codes 116 for all registration cards 112 in a given blister pack 12.20 are recorded and associated as a group, and the registration codes for the group are also associated with the PIN for the package 12.20, which, in turn, is associated with the activation code for that package. The association between each product registration card's product registration code and it's serialization code is made at the time of manufacture of each product registration card 112, which has both codes printed thereon. This association between the serialization codes and the package's PIN and activation code is made by reading the serialization code 116 through the aperture 118 during manufacture, and, with knowledge of the grouping of the serialization codes and their registration codes, the product registration codes for a particular package's PIN and activation code become known. At registration, the step of registering the product by transmitting the PIN over the second communications channel 44 to the computer data storage apparatus 34 causes the computer data storage apparatus 34 to record that the PIN has been registered and that each of the associated product registration codes may then be accepted. Thereafter, for each product registration card 112, the product registration code 114 for that product registration card may be transmitted over a third communication channel to the computer data storage apparatus, at which time the computer data storage apparatus will verify that this product registration code may be accepted because the associated PIN for the package has been previously registered, and the product registration code is then accepted. It shall be understood that the apparatus and procedures used for registering PINs, heretofore described, are equally applicable for registering product registration codes. It shall also be understood that all product registration cards 112 within a given package may have the same serialization code 116 because knowledge of one serialization code 116 through aperture 118 is sufficient to identify all product registration codes 82 within the package. It will thus also be understood that, when the package 12.20 is purchased and its associated PIN activated as with other embodiments of the present invention, all product registration cards 112 in that “multi-pack” package become capable of then having their product registration codes accepted.

The product registration cards 112 preferably have a graphic 120 of a famous athlete or entertainer, and also have a URL 60′ and/or telephone number 59′ at which the product registration codes may be accepted. A purchaser may thus purchase a pack of sports-branded cards or entertainer-branded cards and be directed to the internet web site for that entertainer or sports figure. Likewise, one or more of the product registration cards could be given to friends of the purchaser, and, at the time of transmitting the product registration code to the web site, the friend could then enter the telephone number, or email address, etc., of the purchaser who referred the friend to the web site, and the original purchaser could then receive “bonus points” for use of extra products, thereby encouraging purchasers to give product registration cards to their friends, thereby increasing the “word of mouth” marketing for given entertainers and sports figures, etc. It should be understood that all product registration cards within a given blister package do not need to be the same, and could be for different entertainers (e.g., a “jazz collection” or a “rock music collection”) or could be collector's cards for sports figures. The “product” consumed by use of such cards could be, for example, download of audio music (so-called “MP3” files) or attendance at sporting events, etc.

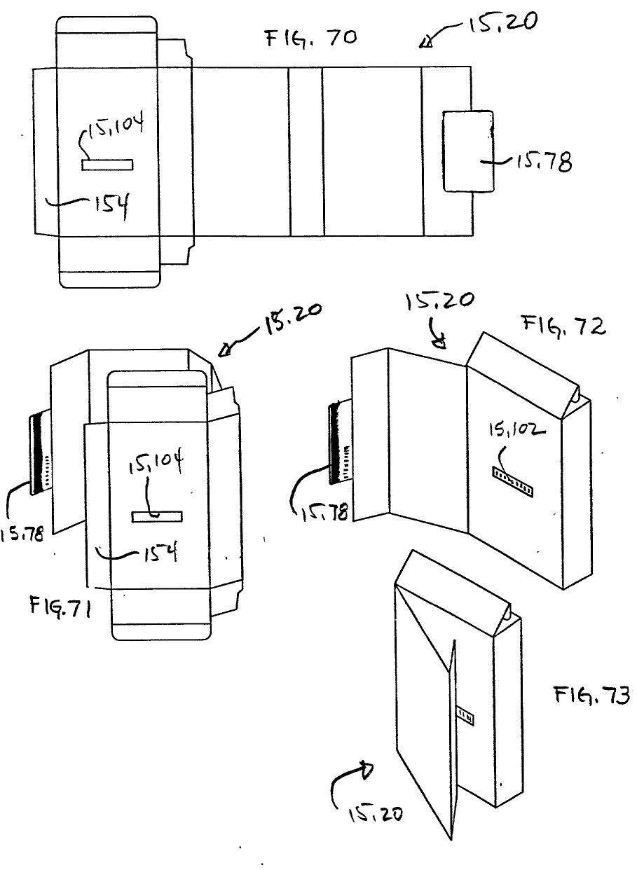

FIG. 70 shows a fifteenth embodiment 15.20 of the present invention, similar to the third embodiment, except that the package may be folded into a gift box. An activation card 15.78 hangs off a portion of the package for activation in the usual manner, and an aperture 15.104 in the box may show a product serialization code therethrough. After activation, the activation card 15.78 may be removed from the package and inserted inside the gift box, as shown in FIG. 73, for wrapping of the box as a present. As is well-known to those in the art, the package may include various flaps 154 to which glue may be applied so as to hold the gift box in its desired three-dimensional form.

FIG. 76 shows a step in the manufacturing process whereby one or more scanners 24 may read the product serialization codes 116 and activation codes from a data-encoded strip 80 or 80′ using an appropriate data-encoded strip reader (22, 24), pass this information on to the computer data storage apparatus 34, where an association may be recorded between the product serialization code and/or PIN and/or activation code, for use at subsequent registration, in a manner hereinbefore described.

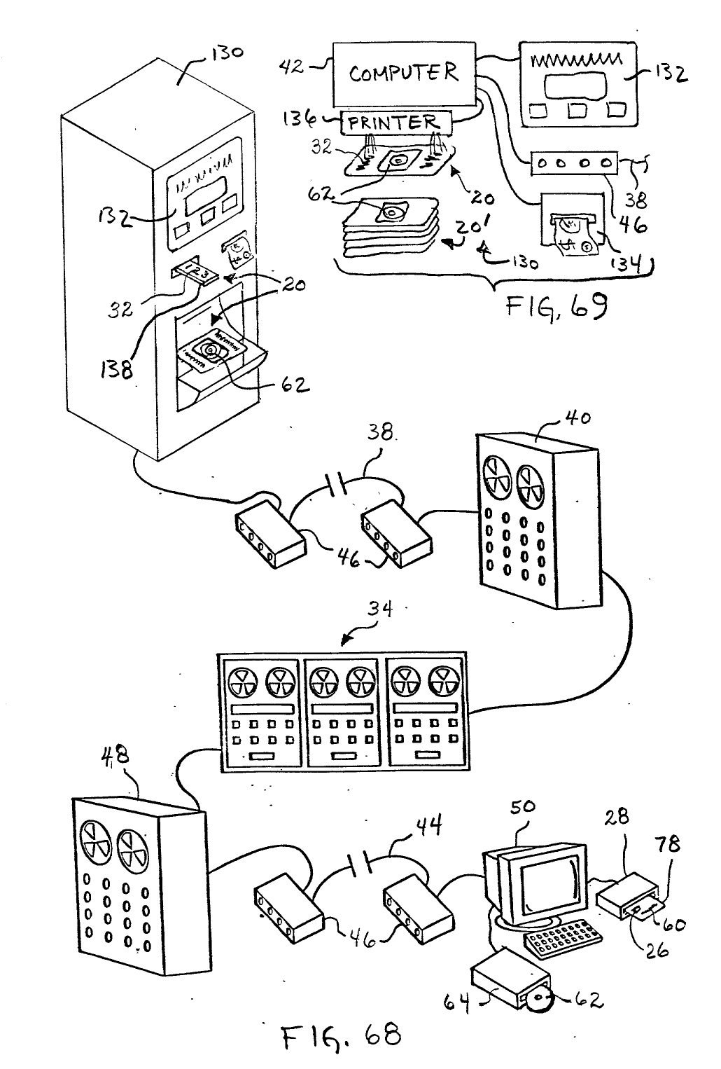

FIGS. 68 and 69 show an embodiment of the present invention in which a kiosk 130 is provided at the POS for vending the product package. Kiosk 130 may have a well-known computer “touch-screen” display 132 and may have a well-known payment acceptor 134 for receiving money such as currency and coins. Kiosk 130 may have a computer 42 that controls operation of the kiosk, and computer 42 may be interfaced to a PIN applicator such as a printer 136 for printing PINs 32 on the vended package 20 at time of sale, and kiosk 130 may be stocked with blank packages 20′ having no PINs yet applied. Computer 42 is preferably in communication with computer data storage apparatus 34 for interchanging activation information with apparatus 34, or computer 42 may be “pre-loaded” with a set of PINs that may be vended, with apparatus 34 likewise having that set of PINs that, once vended, may be subsequently registered. In either of these kiosk embodiments, whether pre-loaded with a set of PINs, or whether in communication with apparatus 34, the kiosk 130 performs a final manufacturing step for the packages 20, namely, affixing a PIN to the package as it is vended.

If the kiosk is in communication with apparatus 34 as over a communication channel 38, then the kiosk may, at each sale event, notify apparatus of the sale event and receive a PIN from the apparatus 34 for printing on the package 20 being vended, and apparatus 34 may then allow registration of the then-vended PIN. Alternatively, kiosk 130 could supply the particular PIN being vended to the apparatus 34 from a pre-loaded set of PINs, notify the apparatus 34 that the PIN was being vended, and apparatus 34 could then enable subsequent registration of the then-vended PIN. It should be noted that none of the kiosk embodiments require an activation code to be on the vended package because the kiosk controls the vending and activation step. If the apparatus 34 supplies the PIN to the kiosk over communications channel 38, then pseudo-random PINs or sequential PINs could be provided to the kiosk, as desired, using algorithmic generation of the PINs.

In its simplest form, kiosk 130 could print and vend a ticket 138 with a PIN 32 on it, and the PIN of such an embodiment might be used for purchase of movie rentals over “pay per view” entertainment channels or for downloading of audio entertainment material. It should be noted that the download channel could also be different from the registration communications channel, such that the PIN may be voice registered as hereinbefore described and then a movie may be viewed on a on pay-per-view cable TV channel, or a PIN may be voice registered followed by download of audio entertainment material over the internet.

Although the present invention has been described and illustrated with respect to preferred embodiments and preferred uses therefor, it is not to be so limited since modifications and changes can be made therein which are within the fall intended scope of the invention.

We claim:

1: A method of point-of-sale activation and subsequent registration of products, said method comprising the steps of:
(a) providing a package by which a product, being unactivated prior to sale, is sold at a point-of-sale, said product having an activation code and said package having a PIN;
(b) providing computer data storage apparatus within which said activation code is associated with said PIN;
(c) transmitting said activation code over a first communications channel from said point-of-sale to said computer data storage apparatus; then,
(d) having said computer data storage apparatus record that said PIN has been activated and may be used to register said product; then,
(e) registering said product by transmitting said PIN over a second communications channel to said computer data storage apparatus.

2: The method as recited in claim 1, further comprising the steps of:
(a) providing a kiosk at said point-of-sale for vending said package, said kiosk being in communication with said computer data storage apparatus over said first communications channel, said kiosk including a PIN applicator for applying said PIN to said package; then,
(b) applying said PIN to said package by said PIN applicator; then,
(c) vending said package at said point-of-sale by said kiosk;
said package having said PIN subsequent to vending of said package by said kiosk but not having said PIN prior to application of said PIN to said package by said PIN applicator.

3: The method as recited in claim 2, in which said PIN applicator is a printer.

4: The method as recited in claim 2, in which said PIN applicator applies a label to said package, said label having said PIN thereon.

5: The method as recited in claim 1, in which said step of registering said product further includes, after said transmitting of said PIN over said second communications channel, the step of receiving an unlocking code for said product over said second communications channel from said computer data storage apparatus.

6: The method as recited in claim 1, in which said package includes a URL via which said computer data storage apparatus may be contacted over said second communications channel, and said method further comprises the steps of:
(a) providing a computer being interfaced to said second communications channel; and
(b) providing a communications program on said computer;
and said step of registering said product further includes, prior to said transmitting of said PIN over said second communications channel, the steps of:
(c) providing said URL to said communications program; and
(d) establishing a data connection to said computer data storage apparatus over said second communications channel via said URL.

7: The method as recited in claim 1, in which said computer data storage apparatus is interfaced to said second communications channel via audio recognition means, and said step of registering said product further comprises, prior to said transmitting of said PIN over said second communications channel, the steps of:
(a) providing a telephone; and
(b) establishing a telephonic connection between said telephone and said audio recognition means over said second communications channel;
and said step of transmitting of said PIN over said second communications channel is via said telephone to said audio recognition means.

8: The method as recited in claim 7, in which said telephone includes audio tone generation means for generating audio tones and said audio recognition means is a telephonic dialing tones recognizer, and said step of transmitting of said PIN over said second communications channel includes the steps of:
(a) causing said audio tone generation means to generate a sequence of telephonic dialing tones representing said PIN; and
(b) recognition of said sequence of telephonic dialing tones by said telephonic dialing tones recognizer.

9: The method as recited in claim 7, in which audio recognition means is an IVR, and said step of transmitting of said PIN over said second communications channel includes the steps of:
(a) causing said PIN to be spoken into said telephone; and
(b) recognition of said spoken PIN by said IVR.

10: The method as recited in claim 1, in which said package includes said activation code and said activation code is machine-readable, and said method further includes the steps of:
(a) providing an activation code reading apparatus at said point-of-sale; and,
(b) prior to transmitting said activation code over said first communications channel, reading said activation code using said activation code reading apparatus when said product is sold at said point-of-sale.

11: The method as recited in claim 10, in which said package includes a magnetic strip onto which said activation code is encoded, and said activation code reading apparatus is a magnetic strip reader.

12: The method as recited in claim 10, in which said activation code is optically readable, and said activation code reading apparatus is an optical scanner.

13: The method as recited in claim 10, in which said package includes an ICC element into which said activation code is encoded, and said activation code reading apparatus is an ICC interface apparatus.

14: The method as recited in claim 10, in which said package obscures said PIN from viewing by a human prior to presentation of said product at said point-of-sale.

15: The method as recited in claim 14, in which said package includes a removable opaque covering and said PIN is obscured by said removable opaque covering.

16: The method as recited in claim 15, in which said activation code is on a top surface of said removable opaque covering.

17: The method as recited in claim 15, in which said removable opaque covering is a scratch-off opaque covering.

18: The method as recited in claim 17, in which said activation code is on a top surface of said removable opaque covering.

19: The method as recited in claim 15, in which said removable opaque covering is a peel-off opaque covering.

20: The method as recited in claim 19, in which said activation code is on a top surface of said removable opaque covering.

21: The method as recited in claim 10, in which said step of registering said product includes the steps of:
(a) providing an PIN-reading apparatus; and
(b) reading said PIN using said PIN-reading apparatus prior to said transmitting of said PIN over said second communications channel.

22: The method as recited in claim 21, in which said package includes a magnetic strip onto which said PIN is encoded, and said PIN-reading apparatus is a magnetic strip reader.

23: The method as recited in claim 21, in which said PIN is optically readable, and said PIN-reading apparatus is an optical scanner.

24: The method as recited in claim 21, in which said package includes an ICC element into which said PIN is encoded, and said PIN-reading apparatus is an ICC interface apparatus.

25: The method as recited in claim 21, in which said package includes computer data storage media onto which said PIN is encoded, and said PIN-reading apparatus is computer data storage media reader.

26: The method as recited in claim 10, in which said step of registering said product further includes, after said transmitting of said PIN over said second communications channel, the step of receiving an unlocking code for said product over said second communications channel from said computer data storage apparatus.

27: The method as recited in claim 10, in which said package includes a URL via which said computer data storage apparatus may be contacted over said second communications channel, and said method further comprises the steps of:
(a) providing a computer being interfaced to said second communications channel; and
(b) providing a communications program on said computer;
and said step of registering said product further includes, prior to said transmitting of said PIN over said second communications channel, the steps of:
(c) providing said URL to said communications program; and
(d) establishing a data connection to said computer data storage apparatus over said second communications channel via said URL.

28: The method as recited in claim 27, in which said step of registering said product further includes the step of transmitting auxiliary registration data over said second communications channel to said computer data storage apparatus.

29: The method as recited in claim 10, in which said computer data storage apparatus is interfaced to said second communications channel via audio recognition means, and said step of registering said product further comprises, prior to said transmitting of said PIN over said second communications channel, the steps of:
(a) providing a telephone; and
(b) establishing a telephonic connection between said telephone and said audio recognition means over said second communications channel;
and said step of transmitting of said PIN over said second communications channel is via said telephone to said audio recognition means.

30: The method as recited in claim 29, in which said telephone includes audio tone generation means for generating audio tones and said audio recognition means is a telephonic dialing tones recognizer, and said step of transmitting of said PIN over said second communications channel includes the steps of:
(a) causing said audio tone generation means to generate a sequence of telephonic dialing tones representing said PIN; and
(b) recognition of said sequence of telephonic dialing tones by said telephonic dialing tones recognizer.

31: The method as recited in claim 29, in which audio recognition means is an IVR, and said step of transmitting of said PIN over said second communications channel includes the steps of:
(a) causing said PIN to be spoken into said telephone; and
(b) recognition of said spoken PIN by said IVR.

32: The method as recited in claim 1, in which said package further includes a plurality of product registration cards, each said product registration card having a product registration code thereon, and within said computer data storage apparatus each said product registration code is associated with said PIN; said step of registering said product by transmitting said PIN over said second communications channel further comprising the step of having said computer data storage apparatus record that said PIN has been registered and that each said product registration code may then be accepted; said method further comprising the steps of, for each said product registration card:
(a) transmitting its said product registration code over a third communications channel to said computer data storage apparatus; then,
(b) having said computer data storage apparatus verify that said its said product registration code may be accepted; then
(c) accepting said product registration code by said computer data storage apparatus.

33: A method of selling products at a point-of-sale with subsequent registration of said products, said method comprising the steps of:
(a) providing a computer data storage apparatus remote from said point-of-sale;
(b) providing a package by which a product, being unactivated prior to sale, is sold at said point-of-sale;
(c) providing a kiosk at said point-of-sale for vending said package, said kiosk being in communication with said computer data storage apparatus over a first communications channel, said kiosk including a PIN applicator for applying a PIN to said package;
(d) transmitting said PIN over said first communications channel and between said kiosk and said computer data storage apparatus;
(e) having said computer data storage apparatus record that said PIN has been activated and may be used to register said product;
(f) applying said PIN to said package by said PIN applicator; then,
(g) vending said package at said point-of-sale by said kiosk; then,
(h) registering said product by transmitting said PIN over a second communications channel to said computer data storage apparatus.

34: The method as recited in claim 33, in which said package includes a URL via which said computer data storage apparatus may be contacted over said second communications channel, and said method further comprises the steps of:
(a) providing a computer being interfaced to said second communications channel; and
(b) providing a communications program on said computer;
and said step of registering said product further includes, prior to said transmitting of said PIN over said second communications channel, the steps of:
(c) providing said URL to said communications program; and
(d) establishing a data connection to said computer data storage apparatus over said second communications channel via said URL.

35: The method as recited in claim 34, in which said step of registering said product further includes the step of transmitting auxiliary registration data over said second communications channel to said computer data storage apparatus.

36: The method as recited in claim 33, in which said computer data storage apparatus is interfaced to said second communications channel via audio recognition means, and said step of registering said product further comprises, prior to said transmitting of said PIN over said second communications channel, the steps of:
(a) providing a telephone; and
(b) establishing a telephonic connection between said telephone and said audio recognition means over said second communications channel;
and said step of transmitting of said PIN over said second communications channel is via said telephone to said audio recognition means.

37: The method as recited in claim 36, in which said telephone includes audio tone generation means for generating audio tones and said audio recognition means is a telephonic dialing tones recognizer, and said step of transmitting of said PIN over said second communications channel includes the steps of:
(a) causing said audio tone generation means to generate a sequence of telephonic dialing tones representing said PIN; and
(b) recognition of said sequence of telephonic dialing tones by said telephonic dialing tones recognizer.

38: The method as recited in claim 36, in which audio recognition means is an IVR, and said step of transmitting of said PIN over said second communications channel includes the steps of:
(a) causing said PIN to be spoken into said telephone; and
(b) recognition of said spoken PIN by said IVR.

39: A method of selling products at a point-of-sale with subsequent registration of said products, said method comprising the steps of:
(a) providing a computer data storage apparatus remote from said point-of-sale;
(b) providing a package by which a product, is sold at said point-of-sale;
(c) providing a kiosk at said point-of-sale for vending said package, said kiosk including a PIN applicator for applying a PIN to said package, said kiosk and said computer data storage apparatus both having a set of PINs that may be vended by said kiosk;
(d) selecting a vended PIN from said set of PINs and applying said vended PIN to said package by said PIN applicator; then,
(e) vending said package at said point-of-sale by said kiosk; then,
(f) registering said product by transmitting said vended PIN over a communications channel to said computer data storage apparatus.

40: The method as recited in claim 39, in which said package includes a URL via which said computer data storage apparatus may be contacted over said communications channel, and said method further comprises the steps of:
(a) providing a computer being interfaced to said communications channel; and
(b) providing a communications program on said computer;
and said step of registering said product further includes, prior to said transmitting of said vended PIN over said communications channel, the steps of:
(c) providing said URL to said communications program; and
(d) establishing a data connection to said computer data storage apparatus over said communications channel via said URL.

41: The method as recited in claim 40, in which said step of registering said product further includes the step of transmitting auxiliary registration data over said communications channel to said computer data storage apparatus.

42: The method as recited in claim 39, in which said computer data storage apparatus is interfaced to said communications channel via audio recognition means, and said step of registering said product further comprises, prior to said transmitting of said vended PIN over said communications channel, the steps of:
(a) providing a telephone; and
(b) establishing a telephonic connection between said telephone and said audio recognition means over said communications channel;
and said step of transmitting of said vended PIN over said communications channel is via said telephone to said audio recognition means.

43: The method as recited in claim 42, in which said telephone includes audio tone generation means for generating audio tones and said audio recognition means is a telephonic dialing tones recognizer, and said step of transmitting of said vended PIN over said communications channel includes the steps of:
(a) causing said audio tone generation means to generate a sequence of telephonic dialing tones representing said vended PIN; and
(b) recognition of said sequence of telephonic dialing tones by said telephonic dialing tones recognizer.

44: The method as recited in claim 42, in which audio recognition means is an IVR, and said step of transmitting of said PIN over said communications channel includes the steps of:
(a) causing said PIN to be spoken into said telephone; and
(b) recognition of said spoken PIN by said IVR.

45: A label for applying to a package, said label having an activation code thereon and said label comprising:
(a) a substrate having a PIN thereon;
(b) a removable opaque covering applied to said substrate over and obscuring said PIN; and
(c) an adhesive backing on said substrate.

46: The label as recited in claim 45, in which said activation code is on a top surface of said removable opaque covering.

47: The label as recited in claim 45, in which said removable opaque covering is a scratch-off opaque covering.

48: The label as recited in claim 47, in which said activation code is on a top surface of said removable opaque covering.

49: The label as recited in claim 45, in which said removable opaque covering is a peel-off opaque covering.

50: The label as recited in claim 49, in which said activation code is on a top surface of said removable opaque covering.
